(19) United States
(12) Patent Application Publication
(10) Pub. No.: US 2013/0177687 A1
(43) Pub. Date: Jul. 11, 2013

(54) Toasting Appliance

(71) Applicant: Man Fai CHEUNG, Kwun Tong (HK)

(72) Inventor: Man Fai CHEUNG, Kwun Tong (HK)

(73) Assignee: HANG SHUN HING COMPANY LIMITED, Kowloon (HK)

(21) Appl. No.: 13/346,814

(22) Filed: Jan. 10, 2012

(51) Int. Cl. A47J 37/08; A23L 1/025

(52) U.S. Cl. 426/466; 99/331; 99/326

(57) ABSTRACT

A toasting appliance includes a pair of elongate radiant elements, and provides relative movement between the radiant elements and the foodstuff to be toasted, so as to traverse the foodstuff with the elements, or vice versa. For faster operating speed and improved efficiency, a control circuit receives a toasting-control signal and controls a switch to energise the elements only during a portion of the amplitude of relative displacement produced between the carriage and elements, the portion being defined by the toasting-control signal. Correct movement of the elements is monitored by a control circuit that de-energises the elements when, due to a fault, one of the elements and the carriage departs from a defined velocity profile.

### TECHNICAL FIELD

The present invention relates generally to toasting appliances, and more particularly to toasting appliances having elongate radiant elements, and which provide for relative movement between the radiant elements and the foodstuff to be toasted, so as to traverse the foodstuff with the elements, or vice versa.

### BACKGROUND OF THE INVENTION

U.S. Pat. No. 6,668,706 describes a toaster of the above-mentioned type, in which a pair of elongate radiant elements are arranged upright and scan back and forth across the foodstuff to simultaneously toast both sides. This arrangement provides high speed operation compared to conventional toasters incorporating planar elements. A window is provided in the body of the toaster for viewing the moving elements and the item being toasted. Owing to the regular movement required to complete each toasting cycle a visual indication is provided to the user of the remaining toasting time. While this toaster therefore offers advantages, there remains a need for improvements in the operating speed, efficiency and safety of toasting appliances of this type. It is an object of the present invention to address this need or, more generally, to provide an improved toasting appliance.

### DISCLOSURE OF THE INVENTION

According to one aspect of the present invention there is provided a toasting appliance for toasting a foodstuff, comprising:
a carriage for supporting the foodstuff;
element means comprising either a pair of elongate radiant elements or a single elongate radiant element;
a switch controlling power supply to the element means;
a motorised drive for producing relative reciprocating displacement between the element means and the carriage in a direction substantially transverse to the element means so as to traverse the foodstuff with the element means, or vice versa;
a toasting-control signal generator for generating a toasting-control signal, and
a control circuit that receives the toasting-control signal and controls the switch to energise the element means only during a portion of the amplitude of relative displacement produced between the carriage and element means, the portion being defined by the toasting-control signal.

Preferably the toasting appliance provides two-sided toasting simultaneously, and the element means comprises the pair of elongate radiant elements, between which the foodstuff is toasted. Preferably the elements of the pair are substantially parallel to one another, and most preferably the elements of the pair are linear. Preferably the element means is fixed at one end to the mount. Optionally, the element or elements may comprise a wire, ribbon or strip.

Optionally, the toasting appliance toasts only a single-side of the foodstuff during the portion of the amplitude of relative displacement during which the element is energised, and the element means comprises only a single elongate radiant element.

Preferably the toasting appliance further comprises a chassis, and the carriage is mounted for reciprocating movement relative to the chassis. Most preferably, the reciprocating movement is vertical such that the carriage is raised to eject the foodstuff.

Preferably the toasting appliance further comprises a mount member reciprocated by the motorised drive, one of the carriage and the element means being mounted to the mount member, the other of the carriage and element means being mounted to the chassis.

Preferably the portion of the amplitude of relative displacement during which the element is energised extends between a start position and an opposing end position, and the control circuit controls the switch to vary the start position, or the end position, between first and second spaced apart positions, according to the toasting-control signal, and controls the switch to de-energise the element means at the end position.

Preferably the toasting-control signal generator comprises a user-actuable control for allowing the user to select between a plurality of discrete start or end positions corresponding to the size, or to the number, of items toasted. The user control may allow the user to select between the plurality of discrete start or end positions in a stepwise manner, alternatively the user control may allow the positions to be varied substantially continuously. Optionally the toasting-control signal generator may comprise sensors, such as optical sensors, for detecting the size or number of foodstuff items, and consequently the start or stop positions.

Preferably the appliance further comprises a housing having a window through which the element means is visible.

Preferably the motorized reciprocating drive comprises a reversible rotary electric motor connected to turn a screw, the mount having an internal thread engaged with the screw, and further comprising a rotary encoder in the control circuit for determining an angular position of the screw. Optionally the rotary encoder may comprise a disc portion which rotates with the screw, the disc portion comprising a regular angularly spaced array of apertures, and a cooperating optical emitter and receiver on opposing sides of the disc portion. The disc portion may be a portion of a gear arranged for transmitting torque between the rotary electric motor and the screw.

Preferably the screw extends upright, and the carriage is mounted on a guide fixed to the chassis to move up and down in use, the screw and guide being disposed at opposing ends so the carriage, the appliance further comprising a spring for urging the carriage upwardly and an electromagnetic latching mechanism for holding the carriage in a lowered position.

Preferably the elements are fixed to the mount member such that the motorized reciprocating drive reciprocates the pair of elements, and the carriage is secured to the chassis by a guide which restrains the carriage to reciprocate linearly relative to the chassis. Alternatively, if the carriage is fixed to the mount, the pair of elements may be fixed to the chassis, such that the motorised reciprocating drive reciprocates the carriage.

In another aspect the invention comprises a toasting appliance for toasting a foodstuff, comprising:
a carriage for supporting the foodstuff;
element means comprising a pair of elongate radiant elements or a single elongate radiant element;
a switch controlling power supply to the element means;
a motorized drive for producing relative reciprocating displacement between the element means and the carriage in a direction substantially transverse to the element means so as to traverse the foodstuff with the element means, or vice versa;
a control circuit that controls the switch to energize the element means only during a portion of the amplitude of relative displacement produced between the carriage and element means, and that controls the motorized reciprocating drive for producing the relative reciprocating displacement according to a velocity profile, and
monitoring means in the control circuit for monitoring the motorized reciprocating drive to provide a safety interlock whereby the control circuit de-energizes the element means when the monitoring means indicates that the relative reciprocating displacement has varied from the velocity profile.

Preferably the motorised reciprocating drive includes a rotary DC electric motor for moving one of the elements and the carriage, and the monitoring means comprises a rotary encoder.

Optionally, the motorised reciprocating drive includes a stepper motor for moving one of the elements and the carriage, the stepper motor having an open loop driver and the monitoring means comprising a feedback from the open loop driver to the control circuit.

Preferably the velocity profile comprises a constant velocity and a power output of the elements is maintained substantially constant. Optionally, the velocity profile comprises a variable relative velocity between the carriage and element means, and element power is varied in a compensatory manner in proportion to the variable velocity.

Preferably the elements of the pair are linear and parallel. Preferably radiant power output per unit length of the element is substantially constant throughout the length of the elements.

In yet another aspect the invention comprises a single pass method of toasting a foodstuff, comprising:
receiving a toasting-control signal;
adjusting one of a start position setting and an end position setting according to the toasting-control signal, the start position setting and end position setting defining a start position and an end position respectively;
energising element means comprising a pair of elongate radiant elements or a single elongate radiant element;
actuating a motorised reciprocating drive to move one of the energised element means and the foodstuff linearly relative to the other of the energised element means and the foodstuff from the start position to the end position, so as to traverse the foodstuff with the energised element means, or vice versa; and
de-energising the element means in the end position.

Preferably the element means are energised only during a portion of an amplitude of relative displacement produced between the foodstuff and element means, the portion being defined by the toasting-control signal.

By energising the element means only during a portion of the amplitude of relative displacement by adjusting one of the start position and end position according to the toasting-control signal an energy-efficient and flexible toasting method is provided, particularly suitable for toasting foodstuffs of varying sizes, as well as toasting a varying number of items.

Preferably the method further comprises manually actuating a user control to generate the toasting-control signal. Optionally sensors, such as mechanical or optical sensors, for detecting the size or number of foodstuff items may generate the toasting-control signal.

The user control may allow for the user to select between a plurality of discrete start or end positions. Alternatively, the user control may allow for the user to select between a plurality of discrete start and end positions.

Preferably the motorized reciprocating drive moves the one of the elements and the foodstuff linearly at a substantially constant velocity, and a power output of the elements is maintained substantially constant.

### BRIEF DESCRIPTION OF THE DRAWINGS

Preferred forms of the present invention will now be described by way of example with reference to the accompanying drawings, wherein:

FIGS. 1 and 2 are perspective views from opposing sides of a toaster according to an embodiment of the invention;

FIG. 3 is a perspective view of the toaster of FIGS. 1 and 2, with an outer part of the housing removed;

FIG. 4 is a schematic drawing of the motorised reciprocating drive of the toaster of FIGS. 1 and 2, and

FIG. 5 is a schematic drawing of the control circuit of the toaster of FIGS. 1 and 2.

### DESCRIPTION OF THE PREFERRED EMBODIMENTS

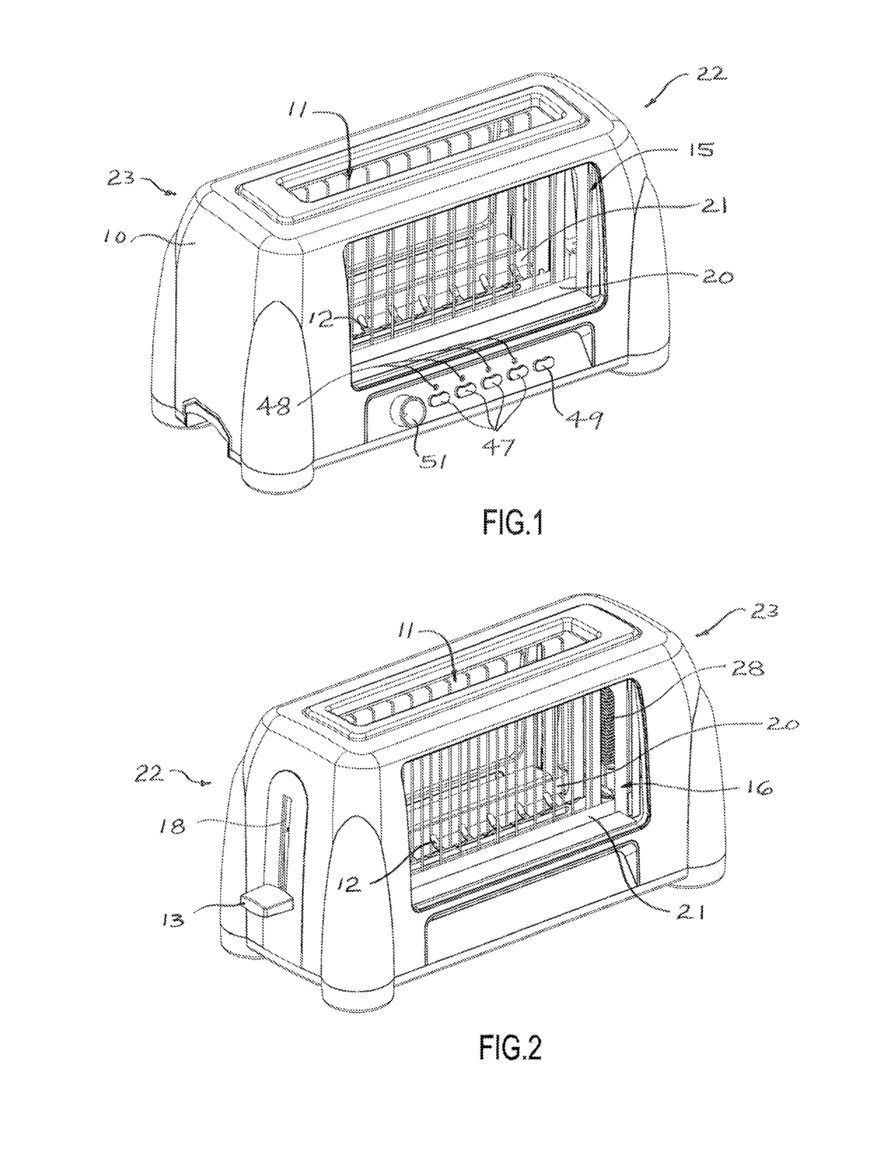

Referring to FIGS. 1 and 2, a toaster according to the invention comprises a housing 10 at the top of which is a slot 11 for receiving a foodstuff such as a slice of bread. The slot 11 extends generally between longitudinally opposing first and second ends 22, 23 of the toaster. The foodstuff is supported upon a carriage 12 visible through windows 15, 16 that are disposed in opposing sides of the housing 10. The toaster is of the pop-up type, with a carriage 12 mounted upon an upright guide 50 at the first end 22, allowing the foodstuff to be lowered for toasting, and automatically raised upon completion of toasting. The carriage 12 may be of a cantilever type, being supported only on the upright guide 50 and extending horizontally to support the foodstuff in a cantilevered manner. A spring 14 is connected at one end to the carriage 12 and at the other end to the chassis 17, so as to urge the carriage 12 upwardly. A handle 13 projecting from an upright slit in the housing is provided for lowering the carriage 12. The toaster may incorporate an electromagnetic latching mechanism (not shown) for holding the carriage 12 in its lowered toasting position, and releasing the carriage 12 upon completion of toasting.

Two radiant elements 20, 21 may be linear, and extend parallel to one another along either side of the slot 11. The pair of elements 20, 21 are spaced apart sufficiently for the item to be toasted to pass between them. One longitudinal end of each of the elements 20, 21 may be fixed at the second end 23 to a mount 24, supporting the elements 20, 21 in a cantilevered manner. The elements 20, 21 may be of tubular form, with reflectors (not shown) for focussing the radiant energy inwardly, toward the slot 11 and the item to be toasted, and away from the windows 15, 16. The power output of the elements is maintained substantially constant and power output per unit length of the elements is substantially constant throughout the length of the elements 20, 21. As shown, both elements 20, 21 lie generally in a horizontal plane.

A screw 28 is mounted upright, with its opposing ends supported in journals (not shown) provided in the chassis 17 allowing the screw to turn about its longitudinal axis. The mount 24 may include an internal thread engaged with the screw 28 for reciprocating the mount 24. The mount 24 may include clamping fixtures 60 for holding ends of the elements 20, 21. The mount 24 is restrained by upright surfaces 61 so as to move up and down without rotation.

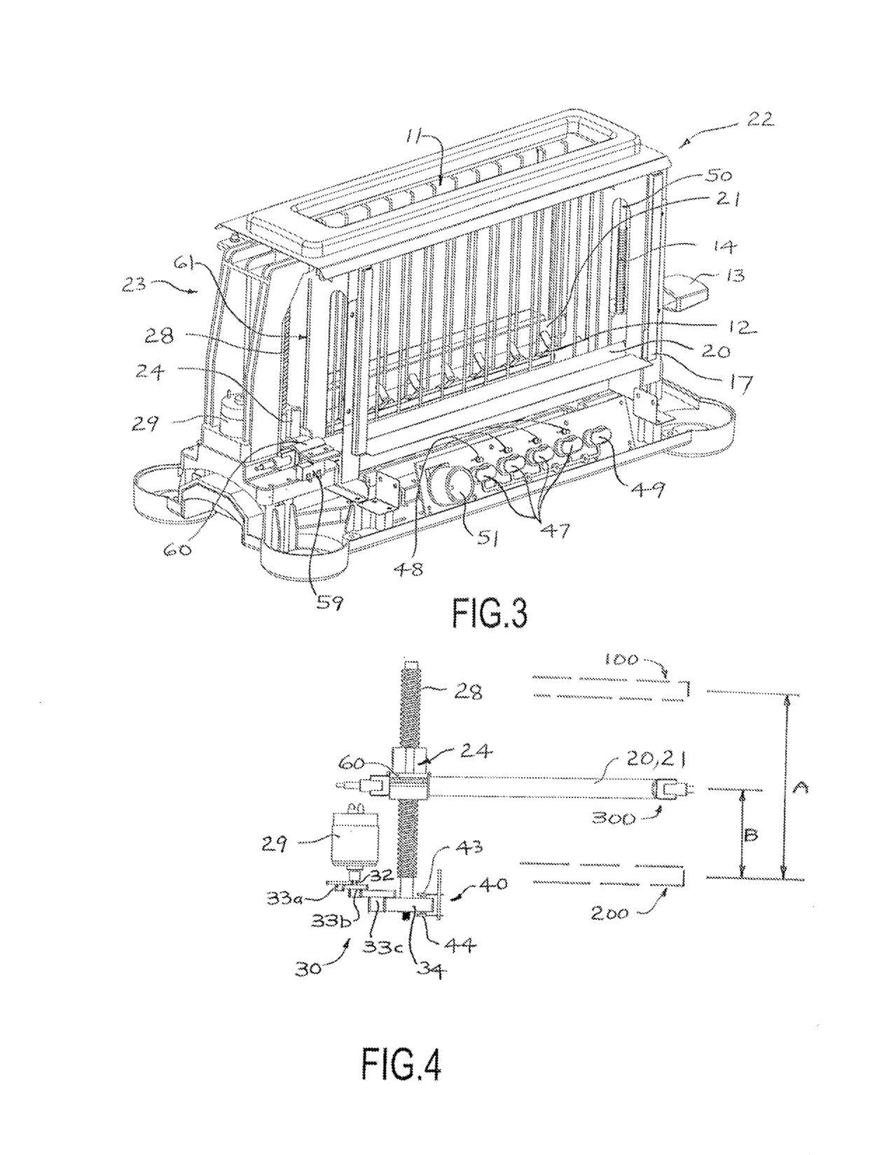

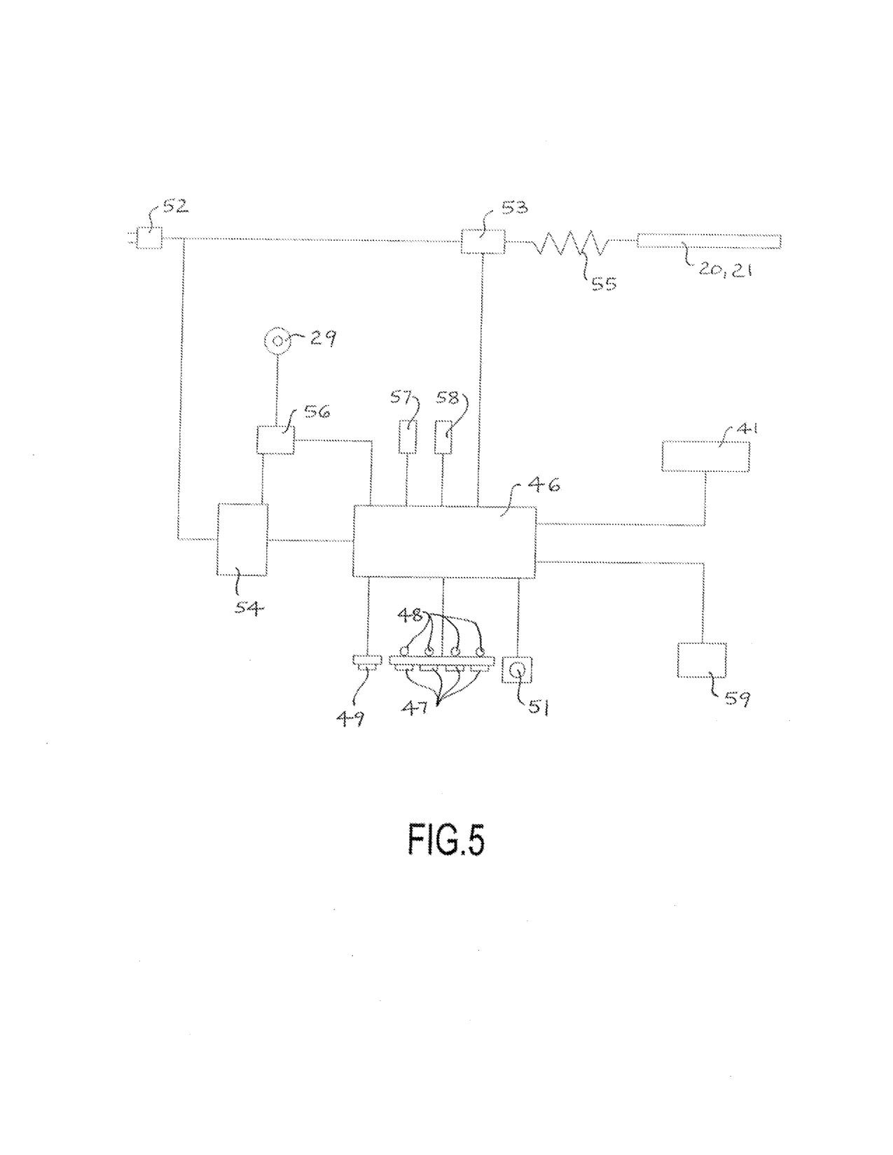

As shown in FIGS. 3 and 4, a motorised reciprocating drive for turning the screw 28 comprises a reversible DC motor 29 connected by a gear train 30 to transmit torque to the screw 28. The gear train 30 may comprise an output pinion 32 fixed on the motor output shaft and a driven gear 34 fixed to rotate with the screw 28, with three intermediate gears 33a, 33b, 33c transmitting torque between the output pinion 32 and driven gear 34. Each of the intermediate gears 33a, 33b, 33c may comprise integral large and small diameter wheels for providing a speed reduction, for instance with the large diameter wheel of intermediate gear 33a being meshed with the output pinion 32, the small diameter wheel of intermediate gears 33c meshed with the driven gear 34, and with the respective small and large diameter wheels of the intermediate gears 33a, 33b, 33c meshed together. Of course this gear train 30 is only an example, and many other combinations achieving a speed reduction and torque multiplication may be used.

In FIG. 4, the elements 20, 21 are shown at a position 300, intermediate upper and lower limits of travel, indicated by the dashed outline of the elements at 100 and 200 respectively. The amplitude A of displacement of the elements 20, 21 is the distance between the upper and lower limits 100, 200, while portion B illustrates a portion of the travel (upward from the lower limit 200, for instance) during which the elements 20, 21 are energised.

A rotary encoder 40 may be provided for feedback for defining the position of the elements 20, 21. The rotary encoder 40 may comprise a regular angularly spaced array of apertures formed as in the driven gear 34 and a cooperating optical emitter 42 and receiver 43 on opposing sides of the driven gear 34.

User controls on the housing may include an array of colour-control switches 47, each with a respective illuminated indicator such as a light-emitting diode (LED) 48. The colour-control switches 47 may be used to define different toasting cycles, or toasting colours. The LEDs 48 serve to indicate the selected toasting cycle. The colour-control switches 47 may be push-to-make switches, and a respective LED 48 may be illuminated at one time to indicate the selected colour-control button 47. The colour-control switches 47 may provide a toggle action, and two adjacent LEDs 48 may be simultaneously to indicate a toasting cycle setting between that defined by two adjacent switches 47.

An eject button 49 can be used to terminate toasting. The eject button 49 may also be a push-to-make switch.

A rotary toasting-control switch 51 can be adjusted to make a selection corresponding to the size of the item to be toasted, in the manner described below. The toasting-control switch 51 may allow continuously variable size selection, or selection in a stepwise manner as between detent positions, each detent position corresponding to a size of item to be toasted.

As shown in FIG. 5, the rotary encoder 40 is connected in a control circuit 45 to a microcontroller 46 which controls the toasting process. The microcontroller 46 also receives inputs from the colour-control switches 47, the toasting-control switch 51 and the eject button 49. The control circuit 45 further comprises a power input 52 connected to a relay 53 and rectifier circuit 54 for providing DC power to the component other than the elements 20, 21. A flexible coupling 55 provides power to the moving elements 20, 21 via the relay 53. A motor controller 56 connected to the motor 29, controls the speed and direction of the motor 29 according to an output from the microcontroller 46. The control circuit 45 includes a start switch 57 actuated by lowering the carriage to the toasting position, and a solenoid 58 of the electromagnetic latching mechanism, the solenoid 58 being actuated to latch and hold the carriage 12 in its lowered toasting position, and de-actuated to release the carriage 12 when the toasting cycle is completed. A position switch 59 is actuated by the mount 24 when the mount 24 is in a predefined starting position, such that the signal from the rotary encoder 40 can be used to define any position of the mount 24 relative to the starting position.

In use, the item to be toasted is dropped through the slot 11 onto the carriage 12, the user then pushing down the handle 13 to lower the carriage 12. The start switch 57 is actuated, as by contact with the mount 24, when carriage 12 in its toasting position, and the microcontroller 46 then energises the latching solenoid 58, to latch down and hold the carriage 12 in position, allowing the handle to be released by the user. The toasting cycle is started by the microcontroller 46 sending a signal to the motor controller 56, to drive the motor 29 at high speed to move the mount 24 and attached elements 20, 21 to their lowermost position 200. The position switch 59 provides an output to the microcontroller 46 indicating that the mount 24 and elements 20, 21 are in the lowermost starting position 200, and initialising a counter in a register in the microcontroller 46. The microcontroller 46 may actuate the relay 53 to energise the elements 20, 21 before the position switch 59 indicates that the mount 24 and elements 20, 21 are in the starting position 200, whereupon the elements 20, 21 are rapidly brought up to operating temperature. Optionally, a short pause may to allow the elements to reach operating temperature.

The colour-control switches 47 and toasting-control switch 51 can be actuated before, or after, these initial operations to start the toasting cycle if the user wishes to vary the toasting cycle from default values. Default values may include an intermediate colour setting for the colour-control switches 47 and a maximum setting on the toasting-control switch 51. In the maximum setting of the toasting-control switch 51 the elements 20, 21 are energised for the full duration of their upward travel of amplitude A. Memory in the microcontroller 46 stores a plurality of predefined toasting cycles, each defining a respective constant motor speed. Depending upon the default or user-selected toasting cycle selected by the colour-control button 47, the microcontroller 46 looks up a corresponding motor speed.

The motor 29 is then driven at the looked up motor speed to raise the energised elements 20, 21 at a constant velocity. The toasting proceeds in a single pass of the foodstuff by the elements 20, 21 during which the counter is incremented by the output of the rotary encoder 41. Toasting may be interrupted by the user actuating the eject button 49, whereupon the microcontroller 46 simultaneously cuts power to the elements 20, 21, the motor 29 and the latching solenoid 58, the carriage then automatically rising to eject the foodstuff.

During the pass of the elements 20, 21 the microcontroller 46 monitors the output of the rotary encoder 41 to provide a safety interlock, whereby if the output of the rotary encoder 41 indicates that the movement of the elements 20, 21 has stopped, or departed from the velocity profile, the microcontroller 46 then opens the relay 53 to de-energise the elements 20, 21. Monitoring the proper movement of the elements 20, 21 in this manner mitigates potential safety problems, such as the possibility that, due to a fault such as jamming or failure of the reciprocating drive, the item being toasted could be burned, or even catch fire.

Different toasting-control signals are received by the microcontroller 46 depending upon the position of the toasting-control switch 51. The toasting-control signal defines a counter value for an end position setting i.e. the value to which the counter is incremented by the time that the elements 20, 21 reach the end position 300 at which the selected scanning movement is to be completed. The microcontroller 46 monitors the counter, and when the microcontroller 46 determines that the counter has reached the counter end position setting, then the relay 53 is opened by the microcontroller 46 to de-energise the elements 20, 21 and the latching solenoid 58 is released, completing the toasting cycle and allowing the now toasted item to pop up. With respect to FIG. 4, the counter end position setting may require the energised elements 20, 21 to be raised to end position 300 for toasting a smaller item. When the elements 20, 21 reach the end position 300, the elements 20, 21 have moved a portion B of their maximum travel, or displacement amplitude A.

By providing windows 15, 16 the user is able to observe the toasting operation, and he may also intervene. For instance, by actuating the colour-control switches 47 during movement of the elements 20, 21 the toasting colour can be varied across the item being toasted. Likewise, if the default setting of the toasting-control switch 51 is too high, the user can turn the toasting-control switch 51 to reduce the setting (and toasting time) when he observes that the item to be toasted has been traversed, thereby immediately terminating toasting.

By varying either end 300 in the manner described, or by varying the start position 200, according to the toasting-control signal from the toasting-control switch 51, smaller size items are toasted more quickly than larger ones, and power is saved due to the elements 20, 21 scanning only the portion B of the amplitude A and being prevented from scanning beyond the limits necessary to toast the selected item. Likewise, for instance, in a toaster able to simultaneously toast two or more items sequentially, when it is desired to toast only a single item the start or end position may be selected so as to avoid wastefully scanning across empty space adjacent to the single item.

Aspects of the present invention have been described by way of example only and it should be appreciated that modifications and additions may be made thereto without departing from the scope thereof. For instance, it will be plain that the carriage may be driven relative to the elements to provide the requisite relative movement, and that the elements may extend vertically instead of horizontally.

1. A toasting appliance for toasting a foodstuff, comprising:
a carriage for supporting the foodstuff;
element means comprising either a pair of elongate radiant elements or a single elongate radiant element;
a switch controlling power supply to the element means;
a motorised drive for producing relative reciprocating displacement between the element means and the carriage in a direction substantially transverse to the element means so as to traverse the foodstuff with the element means, or vice versa;
a toasting-control signal generator for generating a toasting-control signal, and
a control circuit that receives the toasting-control signal and controls the switch to energise the element means only during a portion of the amplitude of relative displacement produced between the carriage and element means, the portion being defined by the toasting-control signal.

2. The appliance of claim 1 wherein the element means comprises the pair of elongate radiant elements, between which the foodstuff is toasted.

3. The appliance of claim 2 further comprising a chassis, and wherein the carriage is mounted for reciprocating movement relative to the chassis.

4. The appliance of claim 3 further comprising a mount member reciprocated by the motorised drive, one of the carriage and the element means being mounted to the mount member, the other of the carriage and element means being mounted to the chassis.

5. The appliance of claim 1 wherein the portion of the amplitude of relative displacement during which the element is energised extends between a start position and an opposing end position, and the control circuit controls the switch to vary the start position, or the end position, between first and second spaced apart positions, according to the toasting-control signal, and controls the switch to de-energise the element means at the end position.

6. The appliance of claim 5 wherein the toasting-control signal generator comprises a user-actuable control for allowing the user to select between a plurality of discrete start or end positions corresponding to the size, or to the number, of items toasted.

7. The appliance of claim 1 further comprising a housing having a window through which the element means is visible.

8. The appliance of claim 1 wherein the motorised reciprocating drive comprises a reversible rotary electric motor connected to turn a screw, the mount having an internal thread engaged with the screw, and further comprising a rotary encoder in the control circuit for determining an angular position of the screw.

9. The appliance of claim 8 wherein the rotary encoder comprises a disc portion which rotates with the screw, the disc portion comprising a regular angularly spaced array of apertures, and a cooperating optical emitter and receiver on opposing sides of the disc portion.

10. The appliance of claim 9 wherein the disc portion is a portion of a gear arranged for transmitting torque between the rotary electric motor and the screw.

11. The appliance of claim 8 wherein the screw extends upright, and the carriage is mounted on a guide fixed to the chassis to move up and down in use, the screw and guide being disposed at opposing ends so the carriage, the appliance further comprising a spring for urging the carriage upwardly and an electromagnetic latching mechanism for holding the carriage in a lowered position.

12. The appliance of claim 1 wherein the elements are fixed to the mount member such that the motorised reciprocating drive reciprocates the pair of elements, and the carriage is secured to the chassis by a guide which restrains the carriage to reciprocate linearly relative to the chassis.

13. A toasting appliance for toasting a foodstuff, comprising:
a carriage for supporting the foodstuff;
element means comprising a pair of elongate radiant elements or a single elongate radiant element;
a switch controlling power supply to the element means;
a motorised drive for producing relative reciprocating displacement between the element means and the carriage in a direction substantially transverse to the element means so as to traverse the foodstuff with the element means, or vice versa;
a control circuit that controls the switch to energise the element means only during a portion of the amplitude of relative displacement produced between the carriage and element means, and that controls the motorised reciprocating drive for producing the relative reciprocating displacement according to a velocity profile, and
monitoring means in the control circuit for monitoring the motorised reciprocating drive to provide a safety interlock whereby the control circuit de-energises the element means when the monitoring means indicates that the relative reciprocating displacement has varied from the velocity profile.

14. The appliance of claim 13 wherein the motorised reciprocating drive includes a rotary DC electric motor for moving one of the elements and the carriage, and the monitoring means comprises a rotary encoder.

15. The appliance of claim 13 wherein the velocity profile comprises a constant velocity and a power output of the elements is maintained substantially constant.

16. The appliance of claim 13 wherein the elements of the pair are linear and parallel.

17. The appliance of claim 13 wherein radiant power output per unit length of the elements is substantially constant throughout the length of the elements.

18. A single pass method of toasting a foodstuff, comprising:
receiving a toasting-control signal;
adjusting one of a start position setting and an end position setting according to the toasting-control signal, the start position setting and end position setting defining a start position and an end position respectively;
energising element means comprising a pair of elongate radiant elements or a single elongate radiant element;
actuating a motorised reciprocating drive to move one of the energised element means and the foodstuff linearly relative to the other of the energised element means and the foodstuff from the start position to the end position, so as to traverse the foodstuff with the energised element means, or vice versa; and
de-energising the element means in the end position.

19. The method of claim 18 wherein the element means are energised only during a portion of an amplitude of relative displacement produced between the foodstuff and element means, the portion being defined by the toasting-control signal.

20. The method of claim 18 further comprising manually actuating a user control to generate the toasting-control signal.

21. The method of claim 18 further comprising receiving a user selection between a plurality of discrete start or end positions.

22. The method of claim 18 further comprising receiving a user selection between a plurality of discrete start and end positions.

23. The method of claim 18 wherein the motorised reciprocating drive moves the one of the elements and the foodstuff linearly at a substantially constant velocity, and a power output of the elements is maintained substantially constant.
